(19) United States
(12) Patent Application Publication
(10) Pub. No.: US 2004/0217557 A1
(43) Pub. Date: Nov. 4, 2004

(54) Chuck apparatus

(76) Inventor: Mei-Chen Wang, Chang Hua Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/427,665

(22) Filed: May 1, 2003

(51) Int. Cl. B23B 31/173

(52) U.S. Cl. 279/56

(57) ABSTRACT

A chuck apparatus includes a socket, a plurality of claws, a plurality of springs and a claw driver. The socket includes a conical portion, a cylindrical portion and a thread formed on an internal face of the cylindrical portion. The claws are put in the conical portion of the socket. Each of the springs is connected and compressed between two of the claws. The claw driver includes a bolt and a thread formed on the bolt for engagement with the thread of the socket so that rotation of the claw driver relative to the socket is transformed to movement, thus pushing the claws toward one another on an internal face of the conical portion of the socket.

### FIELD OF INVENTION

The present invention relates to a chuck apparatus.

### BACKGROUND OF INVENTION

Referring to FIG. 6, a conventional chuck apparatus includes a socket 51 and an insert 52 extending from the socket 51. The insert 52 can be inserted in a tool. A tool bit 60 can be inserted in the socket 52. A bolt 53 can be driven into engagement with the tool bit 60 through a hole (not shown) defined in the socket 51, thus firmly holding the tool bit 60 in the socket 52. Such a conventional chuck apparatus is however made of a fixed size for receiving a tool bit made of a fixed size.

Referring to FIG. 7, another conventional chuck apparatus includes a socket 70, claws 71, springs 72, a pusher 75, a claw driver 73 and a bolt 74. The socket 70 includes a conical portion and a cylindrical portion. Each of the springs 72 is compressed between two of the claws 71. The claws 71 are put in the conical portion of the socket 70. The pusher 75 is put in the socket 70. The chuck driver 73 is put in the cylindrical portion of the socket 70. The chuck driver 73 is engaged with the socket 70 via thread. Thus, rotation of the claw driver 73 transforms into movement of the claw driver 73. The claw driver 73 pushes the claws 71 through the pusher 75. Thus, the claws 71 move toward one another for holding a tool bit. The bolt 74 includes a thread 741 formed thereon. The claw driver 73 includes a thread 731 formed on the wall of a bore defined therein. The thread 741 is engaged with the thread 731, thus connecting the bolt 74 with the chuck driver 73. The bolt 74 includes an insert for insertion in a tool. This conventional chuck apparatus can hold tool bits of various sizes. However, in use, the bolt 74 may slack in the claw driver 73, and the claw driver 73 may slack in the socket 70. Therefore, a tool bit may accidentally escape from this chuck apparatus.

The present invention is therefore intended to obviate or at least alleviate the problems encountered in prior art.

### SUMMARY OF INVENTION

It is the primary objective of the present invention to provide a secure chuck for holding tool bits of various sizes.

According to the present invention, a chuck apparatus includes a socket, a plurality of claws, a plurality of springs and a claw driver. The socket includes a conical portion, a cylindrical portion and a thread formed on an internal face of the cylindrical portion. The claws are put in the conical portion of the socket. Each of the springs is connected and compressed between two of the claws. The claw driver includes a bolt and a thread formed on the bolt for engagement with the thread of the socket so that rotation of the claw driver relative to the socket is transformed to movement, thus pushing the claws toward one another on an internal face of the conical portion of the socket.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the drawings.

FIG. 1 is a perspective view of a chuck apparatus according to the preferred embodiment of the present invention.

FIG. 2 is an exploded view of the chuck apparatus of FIG. 1.

FIG. 3 is a cross-sectional view of the chuck apparatus of FIG. 2.

FIG. 4 is a cross-sectional view of the chuck apparatus of FIG. 3 holding a tool bit.

FIG. 5 is similar to FIG. 3 but showing the chuck apparatus holding another tool bit

### DETAILED DESCRIPTION OF PREFERRED EMBODIMENT

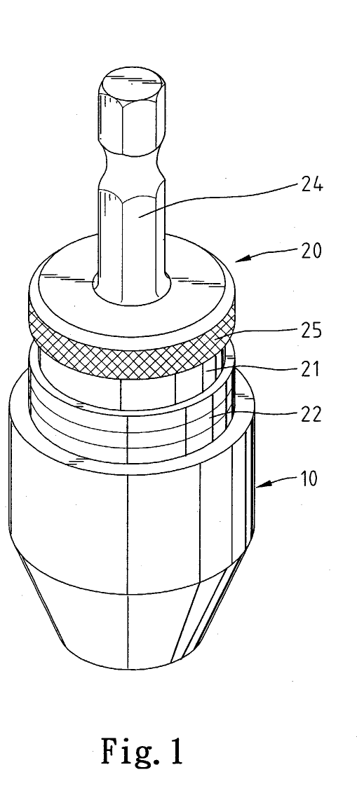

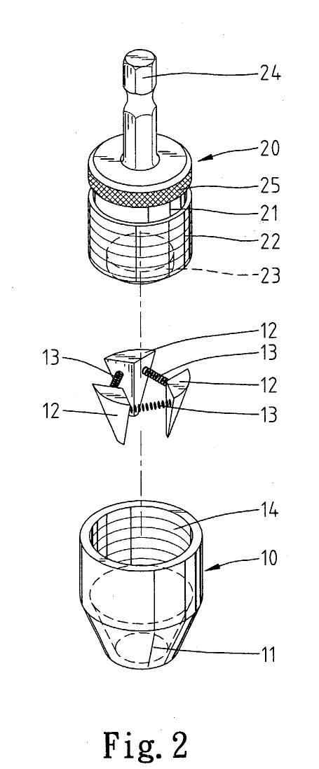

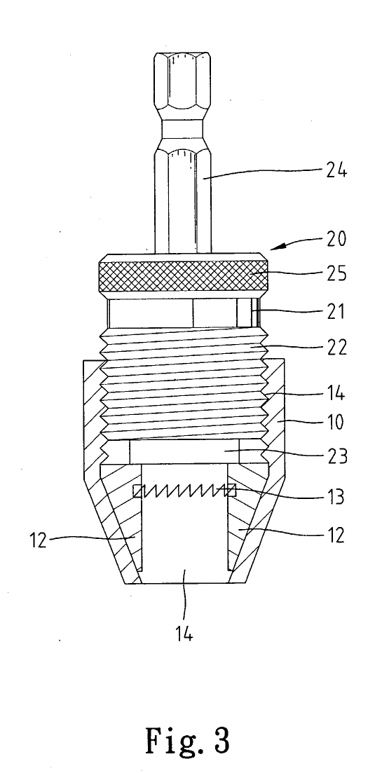

Referring to FIGS. 1˜3, according to the preferred embodiment of the present invention, a chuck apparatus includes a socket 10, three claws 12, three springs 13 and a claw driver 20.

The socket 10 includes a conical portion and a cylindrical portion. The socket 10 includes an internal face 11. A thread 14 is formed on the internal face 11, within the cylindrical portion of the socket 10.

Each of the springs 13 is connected and compressed between two of the claws 12. The claws 12 are put in the conical portion of the socket 10, and so are the springs 13.

The claw driver 20 includes a bolt 21, a thread 22 formed on the bolt 21, a pusher 23 extending from an end of the bolt 21 and an insert 24 extending from an opposite end of the bolt 21. The bolt 21 may be formed with a rough portion 25 so that it can be grabbed firmly.

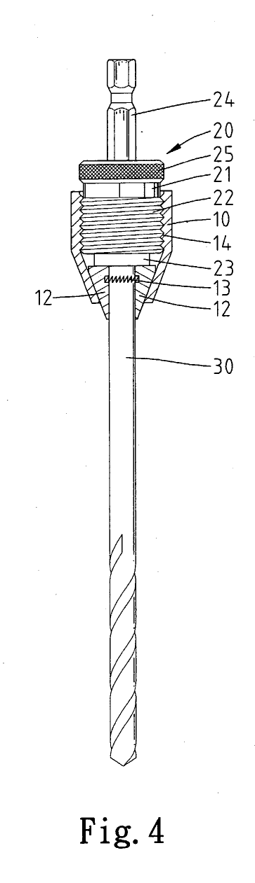

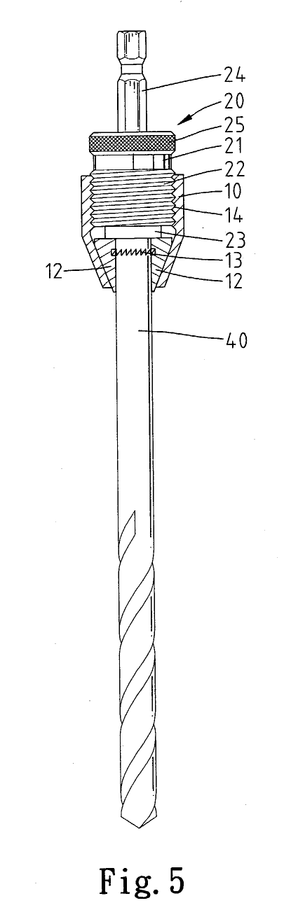

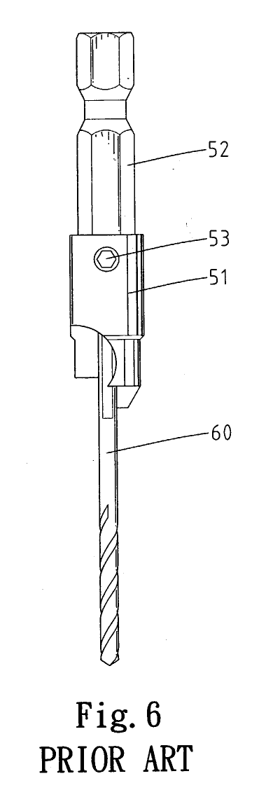

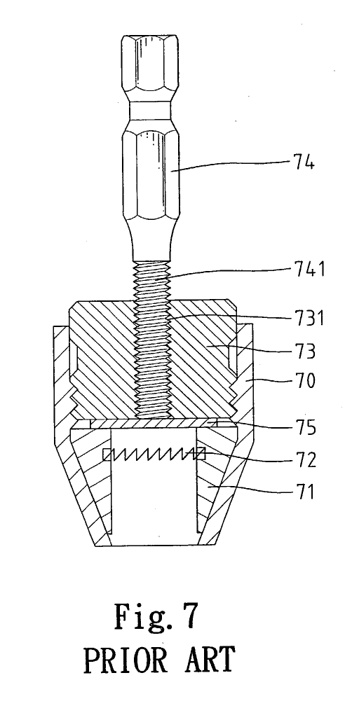

The thread 22 is engaged with the thread 14. Thus, rotation of the claw driver 21 relative to the socket 10 is transformed to movement of the claw driver 21 relative to the socket 10. The pusher 23 pushes the claws 12 to move on the internal face 11 within the conical portion of the socket 10, thus pushing the claws 71 toward one another for holding a tool bit 30 as shown in FIG. 4 or a larger tool bit 40 shown in FIG. 5.

The present invention has been described through detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A chuck apparatus including:
a socket including a conical portion, a cylindrical portion and a thread formed on an internal face of the cylindrical portion;
a plurality of claws installed in the conical portion of the socket;
a plurality of springs each connected and compressed between two of the claws;
a claw driver including a bolt and a thread formed on the bolt for engagement with the thread of the socket so that rotation of the claw driver relative to the socket is transformed to movement, thus pushing the claws toward one another on an internal face of the conical portion of the socket.

2. The chuck apparatus according to claim 1 wherein the claw driver includes an insert formed on the bolt for insertion in a tool.

3. The chuck apparatus according to claim 1 wherein the claw driver includes a pusher formed on the bolt for contact with the claws.

4. The chuck apparatus according to claim 1 wherein the claw driver includes a rough portion formed on the bolt so that it can be grabbed firmly.
